(19) United States
(12) Patent Application Publication
(10) Pub. No.: US 2016/0132652 A1
(43) Pub. Date: May 12, 2016

(54) COMMUNICABLE DISEASE TRACKING

(71) Applicant: EBAY INC., San Jose, CA (US)

(72) Inventors: Richard Chapman Bates, Austin, TX (US); Bryant Luk, Round Rock, TX (US); Robert He, Pflugerville, TX (US); Christopher Diebold O'Toole, Cedar Park, TX (US); Jennifer Brenner, Austin, TX (US); Ananya Das, Austin, TX (US); Jason Ziaja, Cedar Park, TX (US); Yu Tang, Round Rock, TX (US)

(21) Appl. No.: 14/538,358

(22) Filed: Nov. 11, 2014

(51) Int. Cl. G06F 19/00; G06N 7/00

(52) U.S. Cl. CPC G06F 19/345; G06N 7/005

(57) ABSTRACT

Systems and methods for controlling the spread of a communicable disease are provided. A combination of physiological data and location data is used to estimate the likelihood that an individual is ill. Once an individual is determined to be ill, the individual's location history may be examined and individuals who were exposed to the individual identified. By tracking individuals who may be ill or who have reported themselves to be ill, and by identifying individuals with a possible exposure to those who may be ill, potential carriers of illness can be quarantined and their access to areas where communicable diseases pose a high risk limited.

### BACKGROUND

1. Field of the Invention

The present invention generally relates to disease mapping and control, and particularly to controlling the spread of communicable diseases using location and physiological data.

2. Related Art

Many countries and agencies desire to track the spread of disease throughout various locations. In many locations, there is difficulty in collecting and tracking disease information as well as quickly communicating the disease information to people to prevent or alleviate the spread of diseases.

In public health practice, the earliest detection of a disease outbreak offers the best opportunity to mitigate its effects. Consequently, one of the core functions of public health surveillance is to monitor public health status and recognize at the earliest possible time, the appearance of a disease or a change in its distribution or incidence. Early intervention allows for early recognition of affected individuals, initiation of treatment, and initiation of post-exposure mitigations among the exposed population. Surveillance technologies should offer the earliest reliable detection and characterization of outbreaks to afford the greatest opportunity to minimize casualties. A need still exists for systems and methods that provide faster detection and notification of the spread of disease.

### BRIEF DESCRIPTION OF THE FIGURES

FIG. 1 is a block diagram illustrating a system for tracking the spread of a communicable disease according to an embodiment of the present disclosure;

FIG. 2 is a block diagram illustrating a service provider server according to an embodiment of the present disclosure;

FIG. 3 is a flowchart showing a method for tracking the spread of a communicable disease according to an embodiment of the present disclosure; and

FIG. 4 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for controlling the spread of a communicable disease. A “communicable disease” is an infectious disease that can be transmitted from an infected person to another person directly or indirectly. Examples of communicable diseases include the common cold, strep throat, pink eye, whooping cough, flu, malaria, and Ebola. A service provider collects physiological information, such as body temperature and blood pressure from one or more users via a device. Location data is also provided to the service provider. The service provider then analyzes this combination of data to track exposure to and risk of contracting a disease. In various embodiments, a user may report themselves as being ill or diagnosed with a specific disease.

The present disclosure facilitates the analysis of data and/or calculations, to produce an output that relates to disease control, such as the risk of contracting a disease or the risk of exposure to a disease. The analysis may produce a risk calculation, or may be configured so as to produce reporting, or any other communication, based upon collected data.

In some embodiments, the output may be shown in a visual representation, such as a map, which may indicate hot zones of infection or disease, location of infected persons, the location of persons at risk for infection or disease, and/or show the spread of infection or disease over time. Through a review of the visual representations, a user may learn of disease locations and the rate of spread of disease.

Advantageously, the present methods and systems may be used as a tool to curb disease before it spreads, and can further provide a way of calculating risk of disease to people. The methods and systems evaluate location, movement, and intersection of persons to identify a potentially infectious person, make a decision on whether to isolate a person, determine other persons exposed to the potentially infectious person, and/or identify the first infected person in a population.

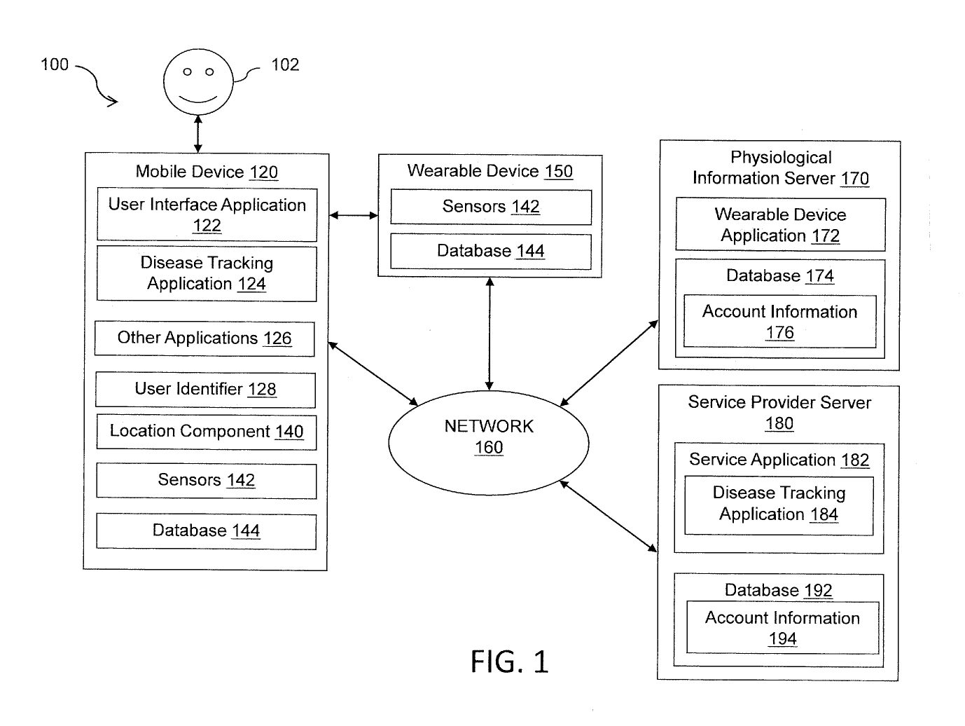

FIG. 1 shows one embodiment of a block diagram of a network-based system 100 that is configured to control the spread of a communicable disease according to an embodiment of the present disclosure. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, system 100 includes mobile device 120 (e.g., a smartphone), a wearable device 150 (e.g., wristband activity tracker, smart watch, etc.), a physiological information server 170, and at least one service provider server or device 180 (e.g., network server device) in communication over a network 160. Network 160, in one embodiment, may be implemented as a single network or a combination of multiple networks. For example, in various embodiments, network 160 may include the Internet and/or one or more intranets, landline networks, wireless networks, and/or other appropriate types of communication networks. In another example, network 160 may comprise a wireless telecommunications network (e.g., cellular phone network) adapted to communicate with other communication networks, such as the Internet. As such, in various embodiments, mobile device 120 and service provider server or device 180 may be associated with a particular link (e.g., a link, such as a URL (Uniform Resource Locator) to an IP (Internet Protocol) address).

Mobile device 120, in one embodiment, is utilized by a user 102 to interact with service provider server 180 over network 160. For example, user 102 may transmit physiological information to service provider server 180 via mobile device 120. Mobile device 120, in various embodiments, may be implemented using any appropriate combination of hardware and/or software configured for wired and/or wireless communication over network 160. In various implementations, mobile device 120 may include at least one of a smartphone, wireless cellular phone, satellite phone, tablet (e.g., iPad™ from Apple®), laptop computer, notebook computer, hybrid/convertible computer, personal computer (PC), and/or other types of mobile computing devices.

Mobile device 120, in one embodiment, includes a user interface application 122, which may be utilized by user 102 to access applications, view physiological information, receive notifications and/or transmit physiological information to service provider server 180 over network 160. In one aspect, user 102 may login to an account related to user 102 via user interface, application 122.

In one implementation, user interface application 122 comprises a software program, such as a graphical user interface (GUI), executable by a processor that is configured to interface and communicate with service provider server 180 via network 160. In another implementation, user interface application 122 comprises a browser module that provides a network interface to browse information available over network 160. For example, user interface application 122 may be implemented, in part, as a web browser to view information available over network 160.

Mobile device 120, in various embodiments, includes a disease tracking application 124. Disease tracking application 124 may be developed by a service provider. Disease tracking application 124 may be downloaded to mobile device 120 from an app store and/or from a service provider website and installed on mobile device 120. Disease tracking application 124 may receive assessments of whether user 102 is sick or ill from service provider server 180, and present the assessments to user 102. Disease tracking application 124, in one embodiment, receives physiological information from user 102 via the mobile device 120 and provides the physiological information automatically to service provider server 180.

Mobile device 120, in various embodiments, may include other applications 126 as may be desired in one or more embodiments of the present disclosure to provide additional features available to user 102. In one example, such other applications 126 may include security applications for implementing client-side security features, programmatic client applications for interfacing with appropriate application programming interfaces (APIs) over network 160, and/or various other types of generally known programs and/or software applications. In still other examples, other applications 126 may interface with user interface application 122 for improved efficiency and convenience.

Mobile device 120, in one embodiment, may include at least one user identifier 128, which may be implemented, for example, as operating system registry entries, cookies associated with user interface application 122, identifiers associated with hardware of mobile device 120, or various other appropriate identifiers. User identifier 128 may include one or more attributes related to user 102, such as personal information related to user 102 (e.g., one or more user names, passwords, photograph images, biometric IDs, addresses, phone numbers, social security number, etc.). In various implementations, user identifier 128 may be passed with a user login request to service provider server 180 via network 160, and user identifier 128 may be used by service provider server 180 to associate user 102 with a particular user account maintained by service provider server 180.

In various implementations, user 102 is able to input data and information into an input component (e.g., a touchscreen, a keyboard, a microphone, etc.) of mobile device 120 to provide physiological information and other user information. The user information may include user identification information.

Mobile device 120, in various embodiments, includes a location component 140 configured to determine, track, monitor, and/or provide an instant geographical location of mobile device 120. In one implementation, the geographical location may include GPS coordinates, zip-code information, area-code information, street address information, and/or various other generally known types of location information. In one example, the location information may be directly entered into mobile device 120 by user 102 via a user input component, such as a keyboard, touch display, and/or voice recognition microphone. In another example, the location information may be automatically obtained and/or provided by the mobile device 120 via an internal or external monitoring component that utilizes a global positioning system (GPS), which uses satellite-based positioning, and/or assisted GPS (A-GPS), which uses cell tower information to improve reliability and accuracy of GPS-based positioning. In other embodiments, the location information may be automatically obtained without the use of GPS. In some instances, cell signals or wireless signals are used. For example, location information may be obtained by checking in using mobile device 120 via a check-in device at a location, such as a beacon. This helps to save battery life and to allow for better indoor location where GPS typically does not work.

Wearable device 150, in various embodiments, is utilized by user 102 to interact with mobile device 120 by local wireless communications, such as Bluetooth low energy (i.e., Bluetooth Smart®), wireless local area network (WLAN), Wi-Fi, near field communications (NFC), etc., or by wired communications, such as by a wired Universal Serial Bus (USB) connection. Wearable device 150 can transmit physiological information to mobile device 120, for example, by wireless syncing via Bluetooth Smart®. Mobile device 120 can, in turn, transmit physiological information to physiological information server 170. Wearable device 150 may communicate with physiological information server 170 and/or service provider server 180 over network 160 via mobile device 120.

Wearable device 150, in other embodiments, is configured to communicate wirelessly over network 160. Wireless device 150 may be utilized by user 102 to interact with mobile device 120, physiological information server 170, and/or service provider server 180 over network 160. For example, user 102 may transmit physiological information to mobile device 120, physiological information server 170, and/or service provider server 180 via wearable device 150.

Wearable device 150, in various embodiments, may be implemented using any appropriate combination of hardware and/or software configured for wired and/or wireless communication. In various implementations, the wearable device 150 includes at least one of an activity tracker (e.g., Flex™ from Fitbit®, UP24™ from Jawbone®, FuelBand™ by Nike®), which may also be called a fitness tracker and/or health tracker, smart watch (e.g., Galaxy Gear™ from Samsung®, Pebble Steel™ from Pebble®), eyeglasses with appropriate computer hardware resources (e.g., Google Glass™ from Google®), and/or other types of wearable computing devices.

Mobile device 120 and/or wearable device 150, in various embodiments, include one or more sensors 142. Mobile device 120 and/or wearable device 150 may use sensors 142 to measure, which may include tracking, monitoring, detecting, quantifying, capturing, and/or otherwise measuring, one or more physiological characteristics. Mobile device 120 and/or wearable device 150 may receive data relating to the physiological characteristics, such as measurements and/or counts of the physiological characteristics, from sensors 142. For example, mobile device 120 and/or wearable device 150 may receive the physiological data by accessing and/or communicating with sensors 142. Mobile device 120 and/or wearable device 150 may process, analyze, infer from, and/or interpret physiological data, such as raw data of sensor measurements, to generate additional physiological information.

Sensors 142 may comprise an accelerometer, gyroscope, actimetry sensor, altimeter, pedometer, heart rate sensor, a time measuring device (e.g., a clock, a timer, or a stopwatch), blood pressure sensor, thermometer, an oximeter or other device capable of sensing and/or measuring the presence and/or concentration of oxygen, carbon dioxide, carbon monoxide, and/or the like in the blood, image sensor, thermal camera and/or microphone. The accelerometer that measures acceleration and the gyroscope that measures orientation may be used together to measure movement, such as an activity of user 102. The accelerometer may be used to measure movement while user 102 is asleep to determine sleep patterns and/or circadian rhythms. The actimetry sensor, which includes an accelerometer and is specialized for measuring movement during sleep, may also be used to determine sleep patterns and circadian rhythms. The altimeter measures altitude and may be used to measure an incline of a path traveled by user 102. The pedometer measures a number of steps taken by user 102. The heart rate sensor, blood pressure sensor, and/or thermometer measure vital signs of user 102.

In one aspect, when interfacing with mobile device 120 and/or wearable device 150, user 102 may elect and/or consent to provide personal information, such as physiological information and/or location information, to physiological information server 170 and/or service provider server 180. User 102 may set or configure the user settings/configuration menu of the mobile device 120 and/or wearable device 150. Through the user settings/configuration menu, user 102 may provide consent to share personal information and specify the extent of the shared personal information. Mobile device 120 and/or wearable device 150 may transmit the physiological information dynamically by push synchronization, periodically, or each time disease tracking application 124 is opened by user 102. In some embodiments, user 102 may be prompted for permission to release personal information. Accordingly, user 102 may have exclusive authority to allow transmission of physiological information and/or location information from the mobile device 120 and/or wearable device 150 to physiological information server 170 and/or service provider server 180.

Mobile device 120 and/or wearable device 150, in many embodiments, include a database 144. Mobile device 120 and/or wearable device 150 may locally store physiological information in database 144. The physiological information, which is based on the physiological characteristics measured by sensors 142, may include physiological data, such as raw data of sensor measurements, the physiological data processed into information relating to physiological characteristics, physiological characteristic history and trends over time, etc.

The physiological information, in many embodiments, includes a variety of types of physiological information. The physiological information may include, for example, sleep-related information, vital sign-related information, activity information, etc. Each type of physiological information may be based on one or more physiological characteristics. One physiological characteristic can be used for more than one type of physiological information. For example, the physiological characteristic of heart rate may be used for sleep-related information, such as to determine whether user 102 is asleep, and also be used for activity information, such as to determine the number of calories burned.

Sleep-related information may include sleep patterns, circadian rhythms, number of hours slept, including number of hours in rapid eye movement (REM) sleep and deep sleep, and/or quality of sleep. Sleep-related information may also include trends and/or averages of each thereof. Sleep-related information may be based on measurements of movement, noise, temperature, heart rate, and/or location of user 102 (e.g., at home or hotel room) by sensors 142.

Activity information may include a number of steps taken, distance traveled by walking, jogging, running, cycling, etc., length of time exercised, and/or calories burned. Activity information may be based on measurements of a step count, incline of path of travel, heart rate, and/or location tracking.

Vital sign-related information may include measured vital signs, measured changes in vital signs, trends and averages over time, and any other information related to vital signs. The vital signs include a heart rate, breathing/respiratory rate, temperature, and blood pressure. The changes in vital signs may be measured to determine whether user 102 is sick or ill.

Mobile device 120 and/or wearable device 150 may transmit physiological information to another user device (e.g., a PC or laptop), physiological information server 170, and/or service provider server 180. The other user device, wearable device 150, physiological information server 170, and/or the service provider server 180 may further process, analyze, infer from, and/or interpret physiological information to generate additional physiological information. The other user device, physiological information server 170, and/or service provider server 180 can store a physiological history that includes long-term physiological information compiled over time, and physiological trends and averages based on the physiological history.

Mobile device 120, wearable device 150, physiological information server 170, and/or service provider server 180, in one embodiment, may take into account various non-physiological information, such as a time of day, location of user 102, schedule of user 102, calendar of user 102, etc. when generating and/or processing physiological information. For example, a time of a day (e.g., night time), a location (e.g., at home, at a vacation location, or at a hotel), a day of the year, and/or a combination of information (e.g., at a store at 2 a.m. for the day after Thanksgiving shopping) may be used to determine and/or infer whether user 102 is sick or well.

Physiological information server 170, in one embodiment, may be maintained by a business entity that produces wearable device 150 (e.g., Fitbit®, Pebble®, Nike®, Samsung®, etc.), a partner of that business entity, and/or by an online service provider. Physiological information server 170 maintains one or more accounts in an account database 174, each of which may include account information 176 associated with an individual users (e.g., user 102) and/or an individual wearable device (e.g., wearable device 150). For example, account information 194 may include physiological information, such as physiological characteristics measured by sensors 142 on wearable device 150. Physiological information server 170 may communicate physiological information to mobile device 120, wearable device 150, and/or service provider server 180.

Physiological information server 170, in one embodiment, includes a wearable device application 172. Wearable device application 172 provides an interface in which user 102 may view physiological information, track trends, and/or process information. For example, user 102 may be able to access wearable device application 172 through a website maintained by physiological information server 170.

Service provider server 180, in various embodiments, may be maintained by a service provider that provides online services and/or processing for information transactions. As such, service provider server 180 includes a service application 182, which may be adapted to interact with the mobile device 120 over the network 160 to facilitate the receipt and analysis of physiological information from mobile device 120, wearable device 150, and/or physiological information server 170. In one example, service provider server 180 may be provided by a service provider such as PayPal®, Inc. (an eBay® company) of San Jose, Calif., USA.

Service provider server 180, in an embodiment, receives physiological information and/or location information from mobile device 120, wearable device 150, and/or physiological information server 170. In certain embodiments, service provider 170 directly receives the physiological information from mobile device 120 and/or wearable device 150 over network 160. In other embodiments, service provider 180 receives the physiological information via an intermediary such as physiological information server 170 because, for example, wearable device 150 does not have connectivity to network 160 and/or the wearable device company that produces wearable device 150 does not makes the data and/or information accessible to third parties. In some embodiments, service provider server 180 receives the physiological information by accessing and/or retrieving the physiological information on mobile device 120, wearable device 150, and/or physiological information server 170.

Service provider server 180, in one embodiment, may be configured to maintain one or more user accounts in database 192, each of which may include account information 194 associated with one or more individual users (e.g., user 102). Account information 194 may include physiological information and/or location information. In various aspects, the methods and systems described herein may be modified to accommodate users that may or may not be associated with at least one existing user account.

Service application 182, in one embodiment, utilizes a disease tracking application 184 to determine whether a user is sick with a communicable disease based on physiological information. For example, if user 102's body temperature is elevated without accompanying measurements indicating physical activity or other explanation, disease tracking application 184 can infer that user 102 is sick. In one implementation, disease tracking application 184 calculates the risk that a user is ill and should be quarantined or at least be limited to exposure with others. The risk calculation may be a combination of multiple risk sub-assessments that may be applied to produce a total risk calculation. For example, besides physiological information of user 102, disease tracking application 184 may further analyze location information, a time of day, schedule of user 102, calendar of user 102, etc. By analyzing location history and finding anomalies (such as user 102 being home or at the doctor's office when they are usually at work), and combining this with physiological data, disease tracking application 184 can infer with high certainty that user 102 is ill. The location information allows disease tracking application 184 to track areas where user 102 visited and who user 102 may have infected or been in contact with, along with where user 102 may be planning to go. Location data can also be used for research purposes to determine onset of symptoms and track diseases throughout populations, including identification of the first infected person within a population, as well as notifying others at locations where user 102 may be planning to go.

The result of the calculation is an indicator that marks the risk that the user is sick with a communicable disease. The indicator may be present in many forms, such as an overall score, a percentile, or it may further be translated to a standardized indicator, such as high, medium, or low. Based on the indicator, the disease tracking application 184 can notify user 102 that he or she is sick, as well as provide recommendations and other actionable information on how to prevent the further spread of disease. For example, establishments that care for individuals with weaker immune systems (such as hospitals or nursing homes) can use this data to prohibit access to those who are known to be ill or may have been exposed to a communicable disease. This can also be applied to areas where healthy individuals are required, such as the donation of blood or plasma. The service provider, such as through the disease tracking application 184, can also notify others that were at locations with user 102, are currently at a location with user 102, or may be at a location user 102 may be going to (e.g., by accessing schedule and/or calendar of user 102), which enables these other users to take desired actions, such as getting a checkup or avoiding a location user 102 may be at in the future.

In one implementation, user 102 may have identity attributes stored with service provider server 180, and user 102 may have credentials to authenticate or verify identity with service provider server 180. User attributes may include personal information and/or physiological information. In various aspects, the user attributes may be passed to service provider server 180 as part of a login, search, and/or selection, and the user attributes may be utilized by service provider server 180 to associate user 102 with one or more particular user accounts maintained by the service provider server 180.

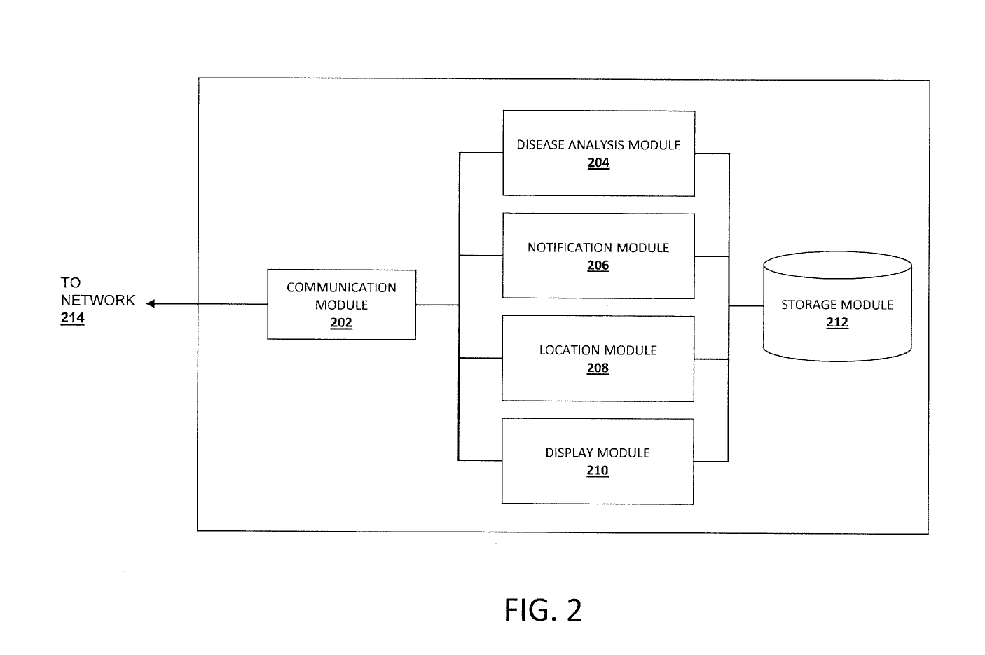

FIG. 2 illustrates an embodiment of a service provider server 180. The server 180 includes several components or modules, such as a communication module 202, disease analysis module 204, notification module 206, location module 208, display module 210, and storage module 212.

The server 180 includes a communication module 202 that is coupled to the network 214 and to any or all of disease analysis module 204, notification module 206, location module 208, and display module 210, any of which may be coupled to a storage module 212. Any or all of the modules 202-210 may be implemented as a subsystem of the server 180 including for example, a circuit, a hardware component, a hardware subcomponent, and/or a variety of other subsystems known in the art. Furthermore, any or all of the modules 202-210 may be preconfigured to perform their disclosed functionality, or may be configured by a processing system “on-the-fly” or as needed to perform their disclosed functionality. As such, any or all of the modules 202-210 may include pre-configured and dedicated circuits and/or hardware components of the service provider server 180, or may be circuits and/or hardware components that are configured as needed.

For example, any or all of the modules 202-210 may be provided via one or more circuits that include resistors, inductors, capacitors, voltage sources, current sources, switches, logic gates, registers, and/or a variety of other circuit elements known in the art. One or more of the circuit elements in a circuit may be configured to provide the circuit(s) that cause the modules 202-210 to perform the functions described above. As such, in some embodiments, preconfigured and dedicated circuits may be implemented to perform the functions of the modules 202-210. In other embodiments, a processing system may execute instructions on a non-transitory, computer-readable medium to configure one or more circuits as needed to perform the functions of the modules 202-210.

The communication module 202 may be included as a separate module provided in the server 180, or may be provided using instructions stored on a computer-readable medium that, when executed by a processing system in the server 180, configure the communication module 202 to send and receive information over the network 214, as well as provide any of the other functionality that is discussed above. The disease analysis module 204 may be included as a separate module provided in the server 180, or may be provided using instructions stored on a computer-readable medium that, when executed by a processing system in the server 180, configure the disease analysis module 204 to receive physiological characteristics from sensors 142, calculate the likelihood that a user is sick, identify a communicable sickness or disease, monitor the status of a user, and query devices for physiological information, as well as provide any of the other functionality that is discussed above. The notification module 206 may be included as a separate module provided in the server 180, or may be provided using instructions stored on a computer-readable medium that, when executed by a processing system in the server 180, configure the notification module 206 to notify users that they are sick and provide suggestions to users to prevent the further spread of disease, as well as provide any of the other functionality that is discussed above. The location module 208 may be included as a separate module provided in the server 180, or may be provided using instructions stored on a computer-readable medium that, when executed by a processing system in the server 180, configure the location module 208 to receive location information from mobile device 120 and/or wearable device 150, as well as provide any of the other functionality that is discussed above. The display module 210 may be included as a separate module provided in the server 180, or may be provided using instructions stored on a computer-readable medium that, when executed by a processing system in the server 180, configure the display module 210 to display a map or other visual representation of locations where infected persons have visited or are located, as well as provide any of the other functionality that is discussed above. While the storage module 212 has been illustrated as located in the server 180, one of ordinary skill in the art will recognize that it may include multiple storage modules and may be connected to the modules 204-210 through the network 214 without departing from the scope of the present disclosure.

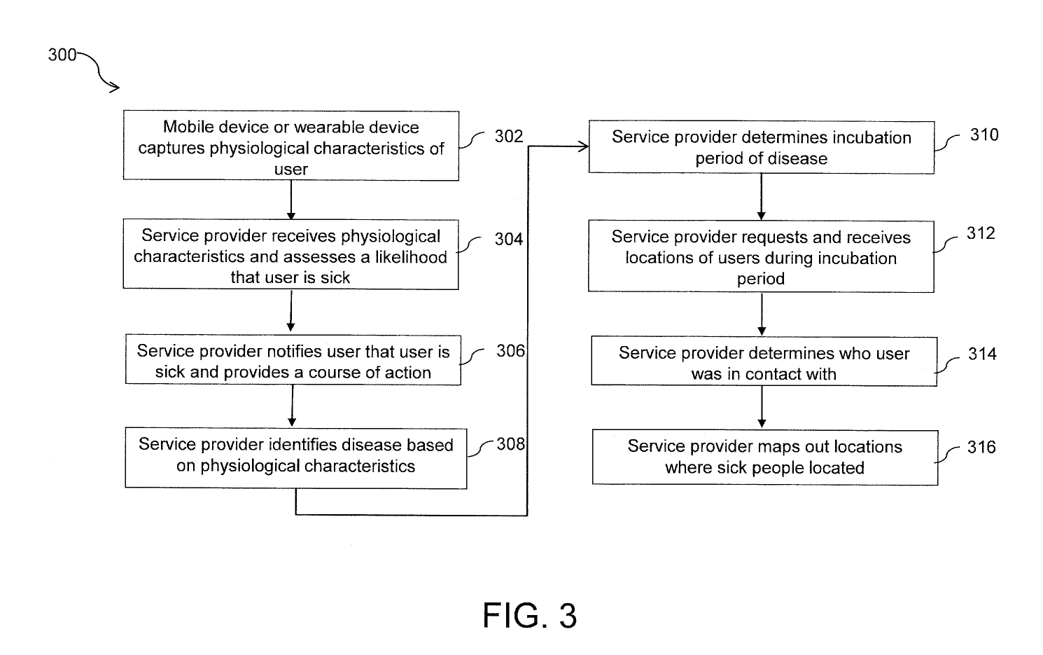

Referring now to FIG. 3, a flowchart of a method 300 for controlling the spread of a communicable disease is illustrated according to an embodiment of the present disclosure. At step 302, mobile device 120 or wearable device 150 measures, which may include tracking, monitoring, detecting, quantifying, capturing, and/or otherwise measuring, one or more physiological characteristics of the user 102. The physiological characteristics can include, for example, physiological data (e.g., vital sign and physical activity data), such as blood pressure, pulse, respiration rate, body temperature, hydration level, physical activity, oxygen consumption, carbon dioxide levels, and glucose or blood sugar level. Physical activities that may be measured include, but are not limited to, walking, running, and swimming.

At step 304, disease analysis module 204 receives the one or more physiological characteristics of user 102 and assesses a likelihood or probability that the user 102 is sick based on the received characteristics. In an embodiment, disease analysis module 204 receives the physiological characteristics from mobile device 120, wearable device 150, and/or physiological information server 170. The extent of physiological information that is received by disease analysis module 204 may depend on user consent and/or election. Disease analysis module 204 may store the physiological information on database 192, and may further process the physiological information.

To assess the likelihood that user 102 is sick, disease analysis module 204 evaluates the one or more physiological characteristics. For example, if user 102 has a higher than normal temperature, increased pulse, increased heart rate, disturbed sleep pattern and low physical activity level, the disease analysis module 204 can infer that user 102 is not well. In various embodiments, disease analysis module 204 inputs the values of the physiological characteristics (e.g., numerical values for body temperature, pulse rate, heart rate, etc.) into a probabilistic model or algorithm to determine a likelihood that user 102 is sick. The probabilistic model may be built using previously collected physiological data. The probabilistic model may output an indicator or score. If the indicator or score exceeds a certain predetermined threshold, then user 102 may be determined to be sick. For example, if the predetermined threshold is set at 50% and the calculated score is 70%, user 102 is determined to be sick. On the other hand, if the calculated score is only 30%, user 102 is determined not to be sick.

In several exemplary embodiments, physiological information may be coupled or combined with non-physiological information such as location of user 102, time of day, and calendar or schedule of user 102 to determine the likelihood that user 102 is sick with a communicable disease. In one implementation, disease analysis module 204 accesses user 102's location and calendar to determine whether user 102 is sick with a communicable disease. For example, disease analysis module 204 may learn that user 102 is at home when he or she is scheduled to be in the office at a meeting. The non-physiological information can increase or decrease the likelihood that user 102 is sick. For example, in the above case, the fact that user 102 is at home rather than in the office increases the likelihood that user 102 is sick. In various embodiments, the non-physiological information may be input into the probabilistic model or algorithm to output a revised score that indicates a revised likelihood that user 102 is sick.

The physiological information may be transmitted to disease analysis module 204 dynamically by automatic synchronization or periodically every predetermined time period (e.g., every 3 hours). For example, mobile device 120 and/or wearable device 150 may measure the physiological characteristics of user 102 and directly transmit the physiological information to service provider server 180. In another example, mobile device 120 and/or wearable device 150 may transmit the physiological information to physiological information server 170, which stores and maintains the physiological information of user 102. Disease analysis module 204 may in turn receive the physiological information from physiological information server 170.

In one embodiment, when user 102 is determined to be sick, further analysis determines whether the sickness is communicable. For example, indications of a headache likely due to causes not communicable through touch or air may result in different actions performed by the system 100. For example, the notification module 206 would not warn user 102 to stay away from others and public places, or warn others who were exposed to user 102. The notification module 206 may still provide suggestions or recommendations to user 102 such as seeing a doctor or getting rest. In some embodiments, disease analysis module 204 may attempt to identify the non-communicable disease by matching the symptoms and signs exhibited by user 102 with known non-communicable diseases.

At step 306, when user 102 is determined to be sick with a communicable disease, notification module 206 notifies user 102 that he or she is sick and provides a course of action to prevent the further spread of the communicable disease. For example, notification module 206 can suggest that user 102 stay home, stay away from certain areas (nursing homes, hospitals, etc.), and/or schedule an appointment to see his or her doctor. In some embodiments, notification module 206 also notifies user 102's doctor to let the doctor know that user 102 is sick so that the doctor can check up on user 102. The one or more courses of action generally include a strategy to control the spread of the communicable disease. The strategy to control the spread of the disease can include one or more of household quarantine, individual quarantine, geographic quarantine, social distancing, hospitalization, school closure, work place closure, travel restrictions, public transit closure, therapeutic treatment or intervention, prophylactic treatment or intervention, vaccination, provision of protective clothing, provision of masks, warning or notification of others, and additional point-of-care testing.

In some embodiments, physiological information of user 102 is periodically monitored to determine how long user 102 is sick or remains contagious. Once the risk level of infection goes down, notification module 206 can notify user 102 that he or she is allowed to go outside and/or back to work.

At step 308, disease analysis module 204 identifies user 102's communicable sickness or disease based on the one or more physiological characteristics. In other words, disease analysis module 204 diagnoses the communicable disease based on the symptoms or signs exhibited by user 102. In the above example, user 102 is experiencing a fever, increased pulse, and increased heart rate, which are signs of the flu. Disease analysis module 204 may examine all the different diseases that have these signs to come up with the best match. For example, disease analysis module 204 may analyze the primary symptoms or signs of a disease to determine a match or eliminate possible diseases, and then use secondary symptoms or signs to narrow down a list of possible diseases.

Once the communicable disease is identified, disease analysis module 204 at step 310 determines the incubation period of the disease. For example, disease analysis module 204 may access a database and search for the specific incubation period. The incubation period is the period between exposure to a pathogenic organism or virus that causes the disease and when symptoms or signs are first apparent. For example, the incubation period for the flu is typically between 24 hours and 4 days, with the average being 2 days. A person can be contagious during the incubation period.

In various embodiments, user 102 reports to the disease analysis module 204 that he or she is sick and identifies the communicable sickness or disease. In these embodiments, there is no need for disease analysis module 204 to analyze physiological information. In certain embodiments, disease analysis module 204 receives both physiological information from a device and information from user 102. For example, disease analysis module 204 may receive blood pressure, heart rate, and respiratory rate data from the device and also data regarding headaches, stomachaches, and fatigue from user 102.

At step 312, location module 208 transmits a request to mobile device 120 regarding locations visited by the user 102 during the incubation period and receives locations visited by user 102. For example, assuming user 102 has the flu, location module 208 queries mobile device 120 regarding the locations visited by user 102 in the last 4 days.

At step 314, location module 208 takes the locations visited by the user 102 during the incubation period and identifies who user 102 was in contact with. For example, location module 208 can take the different locations of user 102 and compare these locations with the locations of other users at the time using GPS. If the locations are within a predetermined distance (e.g., within 1-3 feet) of each other, location module 208 can conclude that the other users were exposed to user 102. In another example, location module 208 determines if two user devices were close enough to communicate or exchange data (such as through Bluetooth technology). If the two users were close enough to exchange information, location module 208 determines that the users were close enough to infect each other.

Once the location module 208 knows who user 102 was in contact with, disease analysis module 204 can query the user devices of those who were contacted or exposed to user 102 for physiological information and determine if those users are sick. If they are sick, the above-described steps can be repeated to determine their locations and who they were in contact with. In certain embodiments, location module 208 can determine the source of the sickness. In various embodiments, notification module 206 notifies those users who are or were in contact with user 102 that they are sick or were in contact with someone who is sick. In certain embodiments, notification module 206 notifies those who may be at a location that user 102 may be visiting of the possible threat. Notification module 206 can also provide a course of action to these users, such as getting a checkup, avoiding certain locations, and/or wearing protective clothing.

At step 316, the display module 210 graphs or maps out all the locations where sick or exposed persons (e.g., user 102 and those exposed or infected by user 102) have visited or are located so that the results are shown visually. The map can be sent out to hospitals, clinics, doctors, and/or users who frequent or live in the area to notify them of the spread of the disease, that they may be in contact with the disease and/or so they can avoid the area.

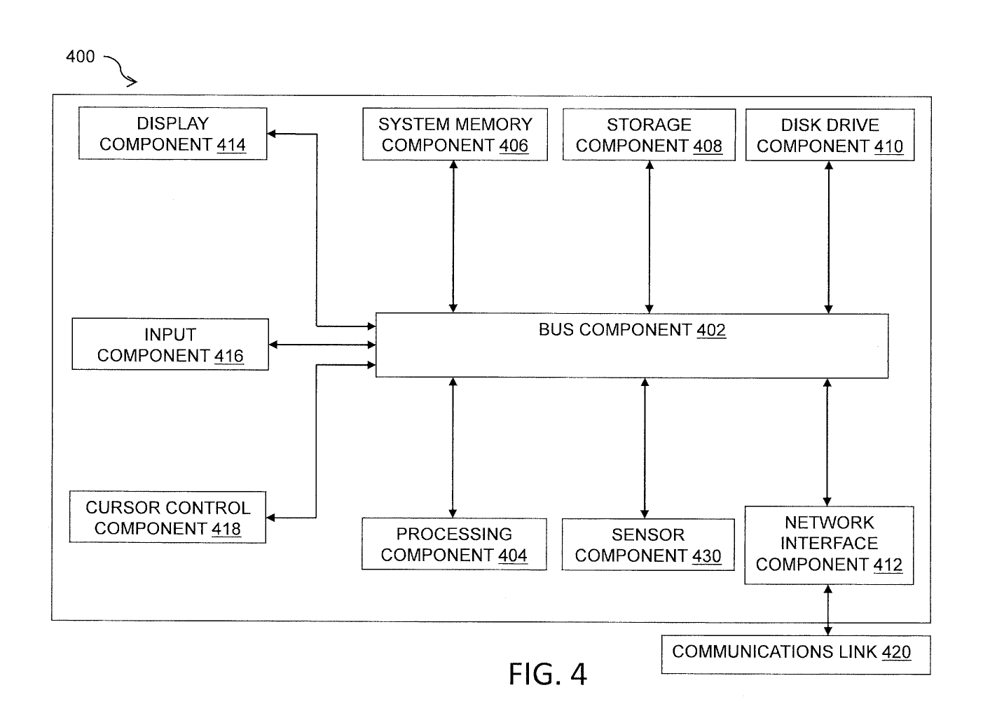

Referring now to FIG. 4, a block diagram of a system 400 is illustrated suitable for implementing embodiments of the present disclosure, including mobile device 120, wearable device 150, physiological information server or device 170, and service provider server or device 180. System 400, such as part of a cell phone, a tablet, a personal computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad or keyboard), a cursor control component 418 (e.g., a mouse pad), and a sensor component 430 (e.g., gyroscope, accelerometer, camera, pedometer, heart rate monitor, etc.).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. These may include instructions to receive physiological information, identify diseases, monitor physiological information, receive location information, provide notifications and courses of action to users, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store visual representations of the different options for searching, auto-synchronizing, storing access control information, making payments, or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., network 160 of FIG. 1, LAN, WLAN, PTSN, or various other wired or wireless networks) may perform instruction sequences to practice the disclosure in coordination with one another. Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

In view of the present disclosure, it will be appreciated that various methods and systems have been described according to one or more embodiments for controlling the spread of a communicable disease.

Although various components and steps have been described herein as being associated with mobile device 120, one or more merchant servers or devices 130, wearable device 150, personal metric information server or device 170, and service provider server or device 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, mobile device, server, and other devices described herein.

What is claimed is:

1. A system, comprising:
a disease analysis module that receives physiological information of a user or a report from a user of a communicable disease, combines the physiological information or report with location information of the user to track the user and identify individuals who were exposed to the user, and queries user devices of the identified individuals for physiological information of the identified individuals;
a location module that requests and receives the location information from a user device of the user; and
a notification module that provides at least one course of action to the user and identified individuals.

2. The system of claim 1, wherein the physiological information comprises one or more of blood pressure, pulse, respiration rate, body temperature, hydration level, physical activity, oxygen consumption, carbon dioxide levels, and glucose or blood sugar level.

3. The system of claim 1, wherein the at least one course of action comprises one or more of household quarantine, individual quarantine, geographic quarantine, social distancing, hospitalization, therapeutic treatment or intervention, prophylactic treatment or intervention, vaccination, use of protective clothing or masks, and additional testing.

4. The system of claim 1, wherein the disease analysis module further receives physiological information of the identified individuals and determines that the identified individuals are ill.

5. The system of claim 4, wherein the notification module further alerts the identified individuals that they are ill.

6. The system of claim 1, wherein the disease analysis module further monitors the physiological information of the user for a period of time.

7. The system of claim 6, wherein the notification module further alerts the user when the user is no longer contagious.

8. The system of claim 1, further comprising a display module that presents a visual representation of one or more zones of locations of infected persons, location of persons at risk for infection, a spread of infection over time, or any combination thereof.

9. The system of claim 1, wherein the disease analysis module further identifies individuals who are currently at a location with the user, at a location the user is expected to visit, or both.

10. The system of claim 9, wherein the notification module further alerts the identified individuals who are currently at a location with a user, at a location the user is expected to visit, or both, of a risk of infection.

11. A method for controlling the spread of a communicable disease, comprising:
receiving, by a disease analysis module of a service provider from sensors on a user device, physiological information of a user;
receiving, by a location module of the service provider from the user device, location information of the user;
determining, by the disease analysis module, that the user is ill with a communicable disease based on the physiological information and the location information;
alerting, by a notification module of the service provider, the user that the user is ill;
identifying, by the disease analysis module, the communicable disease based on the physiological information; and
evaluating, by the disease analysis module, the location information, movement of the user, and intersection of the user with other individuals to identify individuals exposed to the communicable disease.

12. The method of claim 11, further comprising receiving, by the disease analysis module, calendar or schedule information of the user.

13. The method of claim 12, further comprising combining, by the disease analysis module, the calendar or schedule information with the physiological information and location information to determine that the user is ill.

14. The method of claim 11, further comprising determining, by the disease analysis module, an incubation period of the identified communicable disease.

15. The method of claim 14, further comprising requesting, by the location module to the user device, locations visited by the user during the incubation period.

16. The method of claim 15, further comprising identifying, by the location module, the intersection of the user with other individuals.

17. A non-transitory computer-readable medium comprising executable modules which, in response to execution by a computer system, cause the computer system to perform a method comprising:
receiving, by a disease analysis module of a service provider from sensors on a user device, physiological information of a user;
receiving, by a location module of the service provider from the user device, location information of the user;
calculating, by the disease analysis module, a likelihood that the user is ill with a communicable disease based on the physiological information and the location information;
alerting, by the notification module of the service provider, the user that the user is ill;
providing, by the notification module, a course of action to the user;
identifying, by the location module, individuals who the user was in contact with; and
presenting, by a display module of the service provider, a visual representation of one or more zones of locations of infected persons, location of persons at risk for infection, a spread of infection over time, or any combination thereof.

18. The non-transitory machine-readable medium of claim 17, wherein calculating the likelihood that the user is ill comprises inputting the physiological information and location information into a probabilistic model.

19. The non-transitory machine-readable medium of claim 18, wherein calculating the likelihood that the user is ill further comprises inputting time of day, calendar information, schedule information, or a combination thereof into the probabilistic model.

20. The non-transitory machine-readable medium of claim 17, wherein the method further comprises requesting, by the disease analysis module, physiological information of the individuals who the user was in contact with.
